(19) United States
(12) Patent Application Publication
(10) Pub. No.: US 2017/0091672 A1
(43) Pub. Date: Mar. 30, 2017

(54) MOTOR DRIVE APPARATUS EQUIPPED WITH FAN MOTOR PREVENTIVE MAINTENANCE FUNCTION

(71) Applicant: FANUC CORPORATION, Yamanashi (JP)

(72) Inventor: Taku Sasaki, Yamanashi (JP)

(73) Assignee: FANUC CORPORATION, Yamanashi (JP)

(21) Appl. No.: 15/276,882

(22) Filed: Sep. 27, 2016

(30) Foreign Application Priority Data
Sep. 30, 2015 (JP) 2015-195036

(51) Int. Cl. G06N 99/00; H02P 29/40; H02P 23/00; H02P 29/68

(52) U.S. Cl. CPC G06N 99/005; H02P 29/68; H02P 29/40; H02P 23/0031

(57) ABSTRACT

A motor drive apparatus equipped with a machine learning device comprises a fan motor and an alarm output unit which provides an indication that it is time to replace the fan motor, wherein the machine learning device comprises a state observing unit which observes the number of revolutions of the fan motor, a reward calculating unit which calculates a reward based on the time that the alarm output unit output an alarm and the time that the fan motor actually failed, an artificial intelligence which judges action value based on an observation result supplied from the state observing unit and on the reward calculated by the reward calculating unit, and a decision making unit which, based on the result of the judgment made by the artificial intelligence, determines whether or not to output an alarm from the alarm output unit.

This application is a new U.S. patent application that claims benefit of JP 2015-195036 filed on Sep. 30, 2015, the content of 2015-195036 is incorporated herein by reference.

### BACKGROUND OF THE INVENTION

1. Field of the Invention

The present invention relates to a motor drive apparatus, and in particular, a motor drive apparatus equipped with a fan motor preventive maintenance function.

2. Description of the Related Art

Conventionally, in a numerical control system comprising a motor drive apparatus and a numerical control apparatus that issues a command to the motor drive apparatus, a fan motor is used to cool heat-generating components provided in the motor drive apparatus. If a fault occurs in the fan motor, the motor drive apparatus may fail to operate due to the heat generated by such components. As a measure to avoid such a situation, it is known to provide a device that outputs a warning when the number of revolutions of the fan motor drops to or below a specified value (for example, refer to Japanese Unexamined Patent Publication No. 2007-200092, hereinafter referred to as “patent document 1”).

The conventional numerical control system disclosed in patent document 1 will be briefly described below. A first storage unit stores a first reference value and a second reference value larger than the first reference value as reference values based on which to determine whether a warning is to be output or not. A display unit displays “WARNING” if each individual detection value obtained as a result of a comparison made by a comparator is larger than the first reference value but not larger than the second reference value and “FAILURE” if the detection value is larger than the second reference value. It is claimed that according to such configuration, the operator can predict the failure of each individual one of a plurality of fan motors and can check each individual motor fan for a failure.

However, in the conventional art, the specified values such as the first and second reference values are determined in advance. Therefore, there has been the problem that the fan motors cannot be replaced at optimum timing in response to changes in the driving environment of each individual fan motor.

### SUMMARY OF THE INVENTION

It is an object of the present invention to provide a motor drive apparatus that predicts failure of a fan motor and outputs a warning by monitoring the variation in the number of revolutions of the fan motor over time.

A motor drive apparatus according to one embodiment of the present invention is a motor drive apparatus equipped with a machine learning device. The motor drive apparatus comprises a fan motor and an alarm output unit which provides an indication that it is time to replace the fan motor. The machine learning device comprises a state observing unit, a reward calculating unit, an artificial intelligence, and a decision making unit. The state observing unit observes the number of revolutions of the fan motor. The reward calculating unit calculates a reward based on the time that the alarm output unit output an alarm and the time that the fan motor actually failed. The artificial intelligence may determine an action value based on an observation result supplied from the state observing unit and on the reward calculated by the reward calculating unit. The decision making unit determines whether or not to output an alarm from the alarm output unit based on the result of the judgment made by the artificial intelligence.

### BRIEF DESCRIPTION OF THE DRAWINGS

The above and other objects, features, and advantages of the present invention will become more apparent from the description of the preferred embodiments as set forth below with reference to the accompanying drawings, wherein:

FIG. 1 is a diagram showing the configuration of a motor drive apparatus according to an embodiment of the present invention;

FIG. 2 is a graph diagram for explaining how the motor drive apparatus according to the embodiment of the present invention predicts the variation in the number of revolutions over time for the future, based on the variation in the number of revolutions over time and failure data recorded as past data from a plurality of past observations;

FIG. 3 is a schematic diagram showing a neuron model used in a machine learning device in the motor drive apparatus according to the embodiment of the present invention;

FIG. 4 is a schematic diagram showing a three-layer neural network model used in the machine learning device in the motor drive apparatus according to the embodiment of the present invention; and

FIG. 5 is a flowchart for explaining the sequence of operations performed by the motor drive apparatus according to the embodiment of the present invention.

### DETAILED DESCRIPTION

A motor drive apparatus according to the present invention will be described below with reference to the drawings.

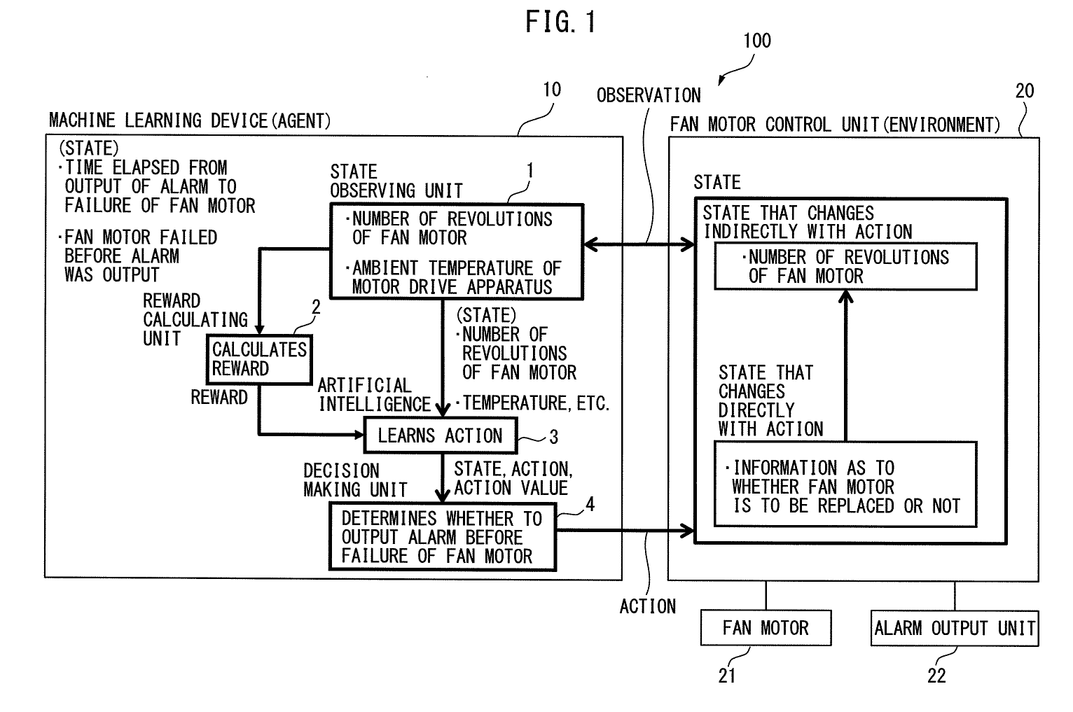

FIG. 1 is a diagram showing the configuration of a motor drive apparatus according to an embodiment of the present invention. The motor drive apparatus 100 according to the embodiment of the present invention comprises a machine learning device (agent) 10 and a fan motor control unit (environment) 20. The machine learning device 10 comprises a state observing unit 1, a reward calculating unit 2, an artificial intelligence (learning unit) 3, and a decision making unit 4. The fan motor control unit 20 includes a fan motor 21 and an alarm output unit 22 which provides an indication that it is time to replace the fan motor 21.

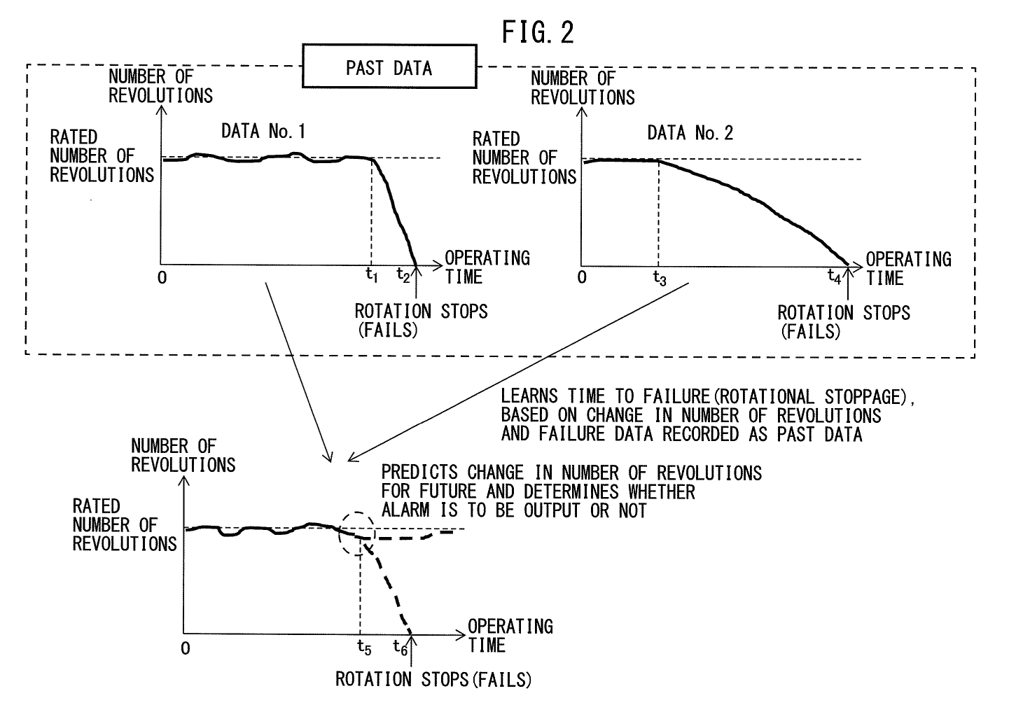

The state observing unit 1 observes the rotational speed of the fan motor 21, that is, the number of revolutions per unit time (hereinafter simply referred to as the “number of revolutions”). FIG. 2 is a graph diagram for explaining how the motor drive apparatus according to the embodiment of the present invention predicts the variation in the number of revolutions over time for the future, based on the variation in the number of revolutions over time and failure data recorded as past data from a plurality of past observations.

The two graphs in the upper part of FIG. 2 each indicate the variation in the number of revolutions of the fan motor 21 over time (temporal variation) as the past data observed by the state observing unit 1. For example, data No. 1 shows an example in which the number of revolutions was almost constant at the rated number of revolutions from time 0 [sec] to time t₁ [sec] but began to drop at time t₁ [sec] and the rotation stopped at time t₂ [sec]. Likewise, data No. 2 shows an example in which the number of revolutions was almost constant at the rated number of revolutions from time 0 [sec] to time t₃ [sec] but began to drop at time t₃ [sec] and the rotation stopped at time t₄ [sec]. In FIG. 2, two pieces of data are shown as the past data, but three or more pieces of data may be used as the past data.

The alarm output unit 22 outputs an alarm indicating that it is time to replace the fan motor 21 in accordance with the variation in the number of revolutions of the fan motor 21 over time. For example, the alarm output unit 22 may be configured to output an alarm when the number of revolutions of the fan motor 21 drops below X [%] of the rated number of revolutions. Alternatively, the alarm output unit 22 may be configured to output an alarm when the number of revolutions of the fan motor 21 drops below a predetermined number of revolutions Y [min⁻¹]. Further alternatively, the alarm output unit 22 may be configured to output an alarm when the time elapsed from the instant that the fan motor 21 started to rotate has exceeded a predetermined length of time Z [hour]. However, these are only examples, and the alarm may be output based on other criteria.

The reward calculating unit 2 calculates a reward based on the time that the alarm output unit 22 output the alarm and the time that the fan motor actually failed. The reward calculating unit 2 may be configured to calculate a higher reward as the time elapsed from the output of the alarm until the fan motor actually failed is shorter. The reward calculating unit 2 may also be configured to calculate a higher reward when the alarm was not output and the fan motor 21 continued to rotate without failing. Further, the reward calculating unit 2 may be configured to calculate a lower reward when the fan motor 21 failed before the alarm was output.

The artificial intelligence (learning unit) 3 can judge action value based on the observation result such as the number of revolutions of the fan motor 21 observed by the state observing unit 1 and on the reward calculated by the reward calculating unit 2. Further, the state observing unit 1 may also observe the ambient temperature of the motor drive apparatus 100, and the artificial intelligence 3 may judge the action value by also considering the ambient temperature. Alternatively, the state observing unit 1 may also observe the current consumption of the fan motor 21, and the artificial intelligence 3 may judge the action value by also considering the current consumption. Further alternatively, the state observing unit 1 may also observe a variation in the number of revolutions of the fan motor 21 at power on and at power off, and the artificial intelligence 3 may judge the action value by also considering the variation in the number of revolutions occurring at such times.

Preferably, the artificial intelligence 3 performs, using a multilayer structure, computational operations on the state variables observed by the state observing unit 1, and updates in real time an action value table which is used to judge the action value. As a method of performing computational operations on the state variables using a multilayer structure, a multilayer neural network such as shown in FIG. 4, for example, can be used.

The decision making unit 4, based on the result of the judgment made by the artificial intelligence 3, determines whether or not to output an alarm from the alarm output unit 22. The decision making unit 4 learns the time to failure (rotational stoppage), based on the variation in the number of revolutions and failure data recorded as the past data, and predicts the variation in the number of revolutions for the future to determine whether the alarm is to be output or not. For example, as shown in FIG. 2, whether or not to output the alarm at time t₅ [sec] is determined based on the data No. 1 and No. 2. After that, the fan motor 21 either stops rotating (fails) at time t₅ [sec] or continues to rotate without failing. If it is determined that the alarm is to be output at time t₅ [sec], the reward calculating unit 2 calculates a higher reward as the time elapsed from the output of the alarm until the fan motor 21 actually failed is shorter. If it is determined that the alarm is not to be output at time t₅ [sec], then a higher reward is calculated when the fan motor 21 continued to rotate without failing. If the fan motor 21 failed before the alarm output unit 22 output the alarm, a lower reward is calculated. The decision making unit 4 may be configured to output the time to failure of the fan motor 21.

The machine learning device 10 shown in FIG. 1 will be described in detail below. The machine learning device 10 has the function of extracting useful rules, knowledge representation, criteria, etc. through analysis from a set of data input to the apparatus and outputting the result of the judgment while learning the knowledge. There are various methods to accomplish this, but roughly, they are classified into three methods, “supervised learning”, “unsupervised learning”, and “reinforcement learning”. To implement these methods, a method referred to as “deep learning” is known which learns the extraction of feature quantity itself.

In “supervised learning”, the learning unit (the machine learning device) is presented with a large number of data sets, each comprising a given input and a result (label), and learns features contained in the data sets; by so doing, a model for estimating the result from the input, that is, the relationship between them, can be acquired inductively. In the present embodiment, this method can be used to determine the time to replace the fan motor 21, based on the observation result, such as the number of revolutions of the fan motor 21, supplied from the state observing unit 1 and on the reward calculated by the reward calculating unit 2. The above learning can be implemented using an algorithm such as a neural network to be described later.

“Unsupervised learning” is a method that learns the distribution of input data by only presenting the learning unit (the machine learning device) with a large amount of input data and thereby trains the apparatus that performs compression, classification, shaping, etc. on the input data without being presented with corresponding teacher output data. The features contained in the data sets can be clustered, for example, by grouping them into clusters of similar ones. By using the result and by allocating the outputs so as to optimize the result in accordance with certain criteria, the prediction of the output can be achieved. A type of learning referred to as “semi-supervised learning” is also known as an intermediate learning method between “unsupervised learning” and “supervised learning”. The case where some are input and output data and others are only input data corresponds to this type of learning. In the present embodiment, data that can be acquired without actually operating the fan motor is used in unsupervised learning so that the learning can be efficiently performed.

The reinforcement learning problem is set as follows.

The fan motor control unit 20 observes the state of the environment, and determines the action.

The environment changes in accordance with a certain rule, and the action taken may cause a change in the environment.

A reward signal is fed back each time the action is taken.

What is desired to be maximized is the total (discount) reward for the future.

Learning starts from the state that there is no knowledge or incomplete knowledge of the result that would be caused by the action. It is not until the fan motor 21 is actually operated that the fan motor control unit 20 can acquire the result as data. That is, optimum action must be searched for by trial and error.

Learning can be started from a good start point by performing pre-learning to mimic human action (for example, by the above-described supervised learning or by inverse reinforcement learning) and setting the thus acquired state as the initial state.

“Reinforcement learning” is a method that learns not only the judgment and classification but also the action and thereby learns the appropriate action based on the interaction between the action and the environment, i.e., performs learning in order to maximize the reward to be obtained in the future. This signifies that in the present embodiment, an action that may affect the future can be acquired. This method will be further explained, for example, in connection with Q-learning, but should not be limited to the specific case described herein.

Q-learning is a method that learns a value Q(s, a) for selecting an action “a” under a given environment state “s”. That is, under a given state “s”, an action “a” with the highest value Q(s, a) is selected as the optimum action. However, at first, the correct value of Q(s, a) for the combination of the state “s” and the action “a” is not known at all. In view of this, the agent (action entity) selects various actions “a” under the given state “s”, and is presented with a reward for each selected action. In this way, the agent learns to select the better action, and hence the correct value Q(s, a).

As a result of the action, it is desired to maximize the total reward for the future. The final goal is to achieve Q(s, a)=E[Σγ^{t}rₜ] (the expected value of reward discount, where γ is the discount factor) (the expected value is taken for the state change expected to occur when the optimum action is taken. Of course, the optimum action is not known yet, and therefore must be learned by searching.) The update equation for such a value Q(s, a) is expressed, for example, as follows:

$$Q ( {s}_{t} , {a}_{t} ) ← Q ( {s}_{t} , {a}_{t} ) + α ( {r}_{t + 1} + γ {max}_{a} Q ( {s}_{t + 1} , a ) - Q ( {s}_{t} , {a}_{t} ) )$$

where sₜ denotes the environment state at time t, and aₜ the action at time t. With the action aₜ, the state changes to sₜ₊₁. Then, rₜ₊₁ represents the reward that is given as a result of that state change. The term with max is given by multiplying the Q value of the action “a” by γ when the action “a” with the Q value known to be highest at that time was selected under the state sₜ₊₁. Here, γ is a parameter within the range of 0<γ1, and is referred to as the discount factor. On the other hand, α is the learning coefficient, which is set within the range of 0<α≦1.

The above equation shows how the evaluation value Q(sₜ, aₜ) of the action aₜ under the state sₜ is updated based on the reward rₜ₊₁ returned as a result of the trial aₜ. That is, the equation shows that if the evaluation value Q(sₜ₊₁, max aₜ₊₁) of the best action under the next state determined by the “reward rₜ₊₁+action a” is larger than the evaluation value Q(sₜ, aₜ) of the action “a” under the state “s”, then Q(sₜ, aₜ) is increased, and conversely, if it is smaller, then Q(sₜ, aₜ) is reduced. That is, the value of a given action under a given state is brought closer to the value of the best action in the next state determined by that given action and the reward immediately returned as a result of the action.

There are two methods of expressing Q(s, a) on a computer: in one method, the values for all the state/action pairs (s, a) are stored in table form (action value table), and in the other, a function for approximating Q(s, a) is presented. In the latter method, the above update equation can be realized by adjusting the parameters of the approximation function using, for example, a probability gradient descent method or the like. A neural network to be described later can be used as the approximation function.

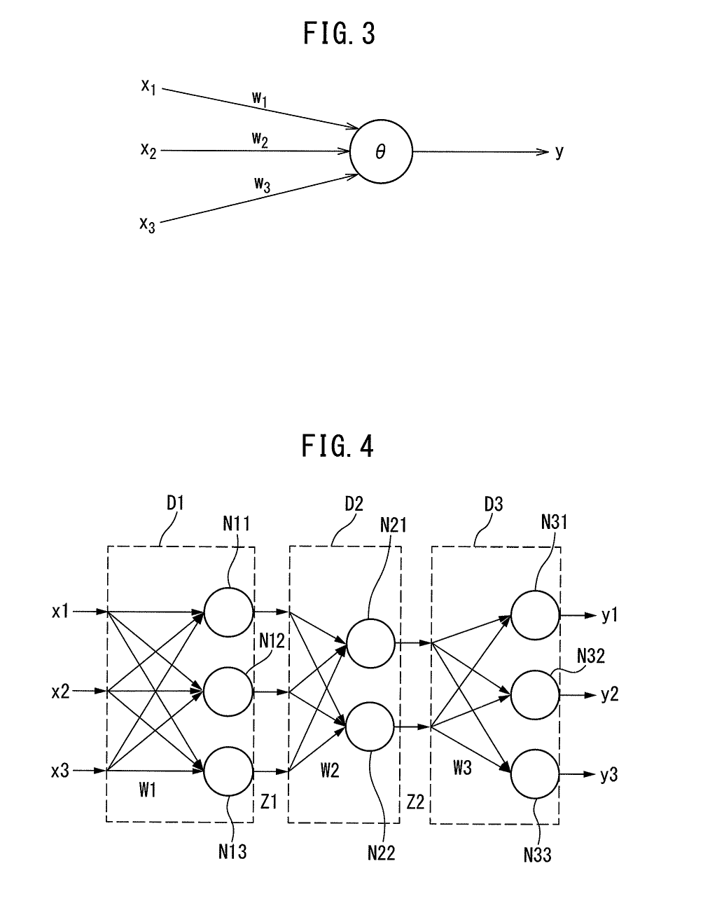

A neural network can be used as the approximation algorithm for the value function in supervised learning, unsupervised learning, and reinforcement learning. The neural network is constructed, for example, using a computing device, memory, etc. for implementing a neural network that mimics a neuron model such as shown in FIG. 3.

As shown in FIG. 3, a neuron is given a plurality of inputs x (as an example, inputs x₁ to x₃) and presents an output y. The inputs x₁ to x₃ are multiplied by weights w (w₁ to w₃) corresponding to the respective inputs x. As a result, the neuron presents the output y expressed by the following equation. Here, the inputs x, the output y, and the weights w are all vector values.

y=fₖ(Σᵢ₌₁ⁿxᵢwᵢ−θ)

where θ is the bias, and fₖ is the activation function.

Next, a neural network having three layers of weights constructed by combining a plurality of such neurons will be described with reference to FIG. 4. FIG. 4 is a schematic diagram showing a neural network having three layers of weights D1 to D3.

As shown in FIG. 4, a plurality of inputs x (as an example, inputs x1 to x3) are input from the left side of the neural network, and results y (as an example, y1 to y3) are output from the right side.

More specifically, the inputs x1 to x3, each multiplied by its corresponding weight, are connected to each of three neurons N11 to N13. The weights by which the respective inputs are multiplied are collectively designated by W1.

The neurons N11 to N13 produce outputs Z11 to Z13, respectively. These outputs Z11 to Z13 are collectively designated as the feature vector Z1 which can be regarded as a vector formed by extracting a feature quantity from the input vector. This feature vector Z1 is the feature vector between the weights W1 and W2.

The outputs Z11 to Z13, each multiplied by its corresponding weight, are input to each of two neurons N21 and N22. The weights by which the respective feature vectors are multiplied are collectively designated by W2.

The neurons N21 and N22 produce outputs Z21 and Z22, respectively. These outputs are collectively designated as the feature vector Z2. This feature vector Z2 is the feature vector between the weights W2 and W3.

The feature vectors Z21 and Z22, each multiplied by its corresponding weight, are input to each of three neurons N31 to N33. The weights by which the respective feature vectors are multiplied are collectively designated by W3.

Finally, the neurons N31 to N33 output the results y1 to y3, respectively.

The neural network has two modes of operation, the learning mode and the value prediction mode; in the learning mode, the weights W are trained using a training data set and, using the resulting parameters, the action of the fan motor is judged in the prediction mode (while the word “prediction” is used here for convenience, various other tasks such as detection, classification, and reasoning are also possible).

In the prediction mode, data obtained by actually operating the fan motor can be immediately learned and reflected in the next action (online learning). Alternatively, first, collective learning may be performed using a set of data collected in advance, and after that, the detection mode may be performed using the resulting parameters throughout the operation (batch learning). It is also possible to employ an intermediate method in which the learning mode is carried out each time a certain amount of data is accumulated.

The weights W1 to W3 can be trained by using an error back propagation method. Error information enters from the right side and flows toward the left side. Back propagation is a method in which the weights are adjusted (trained) so as to reduce the difference between the output y produced for the input x and the true output y (teacher) for each neuron.

Such a neural network may be constructed by increasing the number of layers to more than three (known as deep learning). A computing device that performs feature extraction of the input at various stages and feeds back the result can be automatically acquired only from the teacher data.

The machine learning device 10 of the present embodiment includes the state observing unit 1, the reward calculating unit 2, the artificial intelligence 3, and the decision making unit 4 in order to implement the above-described Q learning. However, the machine learning method applied in the present invention is not limited to the Q-learning. For example, when supervised learning is applied, the value function corresponds to the training model, and the reward corresponds to the error.

As shown in FIG. 1, there are two states in the fan motor control unit 20, i.e., the state that changes indirectly with the action and the state that changes directly with the action. The state that changes indirectly with the action includes the number of revolutions of the fan motor. The state that changes directly with the action includes information as to whether the fan motor is to be replaced or not.

Based on the update equation and the reward, the artificial intelligence 3 updates the action value corresponding to the current state variable and the possible action to be taken from within the action value table.

The machine learning device 10 may be connected to the fan motor control unit 20 via a network, and the state observing unit 1 may be configured to acquire the current state variable via the network. Preferably, the machine learning device 10 resides in a cloud server.

In the example shown in FIG. 1, the action value table stored in the machine learning device is updated using the action value table updated by the artificial intelligence provided in the same machine learning device, but the configuration is not limited to this particular example. That is, the action value table stored in the machine learning device may be updated using an action value table updated by an artificial intelligence provided in a different machine learning device. For example, a data exchange unit for exchanging data between a plurality of motor drive apparatuses may be provided so that the data obtained by learning performed by the machine learning device in one motor drive apparatus can be utilized for learning by the machine learning device in another motor drive apparatus.

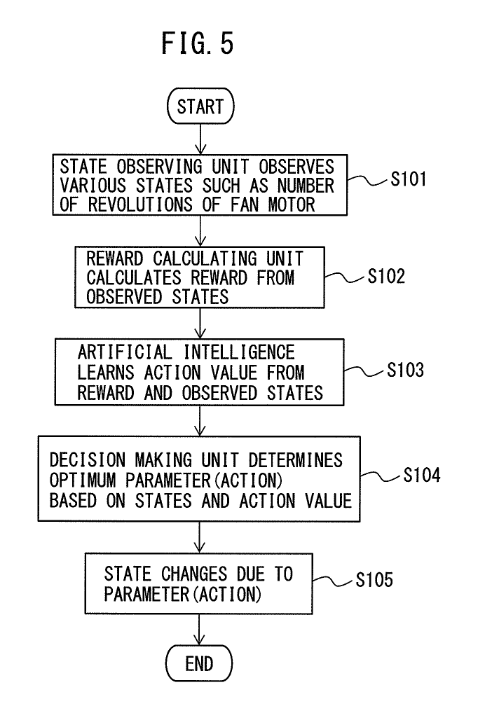

Next, the operation of the motor drive apparatus according to the embodiment of the present invention will be described. FIG. 5 shows a flowchart for explaining the sequence of operations performed by the motor drive apparatus according to the embodiment of the present invention.

First, in step S101, the state observing unit 1 observes the various states of the fan motor 21. More specifically, the state observing unit 1 observes the number of revolutions, temperature, etc. of the fan motor 21.

Next, in step S102, the reward calculating unit 2 calculates the reward from the observed states. For example, the reward calculating unit 2 calculates a higher reward as the time elapsed from the output of the alarm until the fan motor actually failed is shorter, calculates a higher reward when the alarm was not output and the fan motor 21 continued to rotate without failing, and calculates a lower reward when the fan motor 21 failed before the alarm was output.

In step S103, the artificial intelligence 3 learns the action value from the reward and the states observed by the state observing unit 1. More specifically, the artificial intelligence 3 judges the action value based on the number of revolutions of the fan motor 21 observed by the state observing unit 1 and the reward calculated by the reward calculating unit 2. When the state observing unit 1 also observes the ambient temperature of the motor drive apparatus 100, the artificial intelligence 3 may be configured to judge the action value by considering the ambient temperature in addition to the number of revolutions of the fan motor 21. When the state observing unit 1 also observes the current consumption of the fan motor 21, the artificial intelligence 3 may be configured to judge the action value by considering the current consumption in addition to the number of revolutions of the fan motor 21. Further, when the state observing unit 1 also observes a variation in the number of revolutions of the fan motor 21 at power on and at power off, the artificial intelligence 3 may be configured to judge the action value by considering the variation in the number of revolutions in addition to the number of revolutions of the fan motor 21.

In step S104, the decision making unit 4 determines the optimum parameter (action), based on the states and the action value. For example, based on the result of the judgment made by the artificial intelligence 3, the decision making unit 4 determines whether or not to output an alarm from the alarm output unit 22.

In step S105, the state changes due to the parameter (action). That is, the fan motor control unit 20 determines whether or not to replace the fan motor 21.

As described above, according to the motor drive apparatus of the embodiment of the present invention, the fan motor can be replaced at optimum timing, and even when the time to failure changes due to changes in ambient temperature, current consumption, etc. of the fan motor, an alarm can be output at the appropriate timing.

1. A motor drive apparatus equipped with a machine learning device, comprising:
a fan motor; and
an alarm output unit for providing an indication that it is time to replace the fan motor, and wherein:
the machine learning device comprises:
a state observing unit for observing the number of revolutions of the fan motor;
a reward calculating unit for calculating a reward based on the time that the alarm output unit output an alarm and the time that the fan motor actually failed;
an artificial intelligence for judging action value based on an observation result supplied from the state observing unit and on the reward calculated by the reward calculating unit; and
a decision making unit for determining whether or not to output an alarm from the alarm output unit based on a result of the judgment made by the artificial intelligence.

2. The motor drive apparatus according to claim 1, wherein the state observing unit also observes ambient temperature of the motor drive apparatus, and
the artificial intelligence judges the action value by also considering the ambient temperature.

3. The motor drive apparatus according to claim 1, wherein the state observing unit also observes current consumption of the fan motor, and
the artificial intelligence judges the action value by also considering the current consumption.

4. The motor drive apparatus according to claim 1, wherein the state observing unit also observes a variation in the number of revolutions of the fan motor at power on and at power off, and
the artificial intelligence judges the action value by also considering the variation in the number of revolutions.

5. The motor drive apparatus according to claim 1, wherein the reward calculating unit calculates a higher reward as the time elapsed from the output of the alarm until the fan motor actually failed is shorter, calculates a higher reward when the alarm was not output and the fan motor continued to rotate without failing, and calculates a lower reward when the fan motor failed before the alarm was output.

6. The motor drive apparatus according to claim 1, wherein the artificial intelligence judges the action value by also including a variation in the number of revolutions of the fan motor changing over time.

7. The motor drive apparatus according to claim 1, wherein the decision making unit outputs the time to failure of the fan motor.

8. The motor drive apparatus according to claim 1, further comprising a data exchange unit for exchanging data between a plurality of motor drive apparatuses, and wherein
the machine learning device performs learning by also utilizing data obtained by learning performed by a machine learning device provided in another motor drive apparatus.
